(19) United States
(12) Patent Application Publication
(10) Pub. No.: US 2009/0228445 A1
(43) Pub. Date: Sep. 10, 2009

(54) AUTOMATED MOLECULAR MINING AND ACTIVITY PREDICTION USING XML SCHEMA, XML QUERIES, RULE INFERENCE AND RULE ENGINES

(75) Inventor: Rajeev Gangal, Pune (IN)

Correspondence Address: Rajeev Gangal, Systems Biology (I) Pvt. Ltd., 401 Beta 1, Gigaspace, Viman Nagar, Pune, 411014, omitted

(73) Assignee: Systems Biology (1) Pvt. Ltd., Pune (IN)

(21) Appl. No.: 12/190,626

(22) Filed: Aug. 13, 2008

Related U.S. Application Data
(60) Provisional application No. 61/068,237, filed on Mar. 4, 2008.

(51) Int. Cl. G06F 7/00; G06F 17/30

(52) U.S. Cl. 707/3; 707/104.1; 707/102; 707/E17.014; 707/E17.05; 707/E17.01

(57) ABSTRACT

Method and system for analyzing relationship between molecular structure and biological activity in one or more molecules by transforming molecular structure data into a hierarchical representation of chemical concepts and descriptors and detecting common tree-like patterns in the data.

### CROSS-REFERENCES TO RELATED APPLICATIONS

This present application claims priority to the U.S. Provisional Application No. 61/068,237, entitled “Automated Molecular Mining and Activity Prediction using XML Schema, XML Queries, Rule Inference and Rule Engines”, filed Mar. 4, 2008, the entire disclosure of which is hereby incorporated by reference herein.

### BACKGROUND OF THE INVENTION

This invention pertains to the interdisciplinary field of chemo-informatics and chemical structure-activity relationships (SAR) and more particularly to automating transformation of structural information for chemically, biologically or pharmacologically related molecules to a hierarchical schema of concepts and descriptors, discovering patterns in related schema and predicting biological activity using rules inferred from analyzing the patterns.

Informatics is increasingly driving scientific discovery. Bioinformatics and chemo-informatics are interdisciplinary informatics techniques that facilitate ‘in-silico’ experimentation in biology and chemistry respectively. These disciplines implement data mining algorithms to mine molecular data, macromolecular data and small molecules, respectively. Most algorithms originate from computer science and are applied to deciphering the function of proteins, DNA and small molecules. For example, graph-theoretical methods are used for calculating descriptors for organic molecules. Increasingly, bioinformatics and chemo-informatics algorithms are being used together in disciplines such as chemical biology.

Historically, biological data such as protein and DNA sequences, structures, micro-array and proteomics data have been freely available, owing to open policies of worldwide biomedical institutions, such as the NCBI and/or the EBI. Chemical data has been generally proprietary and could be accessed as a paid service or product. The advent of open databases such as PubChem (which can for example be accessed at the URL pubchem.ncbi.nlm.nih.gov) has changed the dynamics of data access, so much so that many chemical suppliers are freely and increasingly submitting their data into PubChem. Some of these chemical data are linked to pharmacological and/or biological classes using the MeSH schema (the U.S. National Library of Medicine's controlled vocabulary used for indexing articles for MEDLINE/PubMed). There are several other databases that also link toxicological and other biological information with chemical structure. The information might be quantitative, e.g., minimum inhibitory concentration (MIC) values, or qualitative, e.g., “the molecule is hepatotoxic” or “the molecule is anti-infective.” Where the information is qualitative, care has been taken by the curators to follow a standard definition or threshold for determining when a molecule should be called active or toxic.

The number of molecules in the PubChem database now exceeds 18 million. This enormous amount of chemical and biological data, while useful, raises an important data mining challenge of relating biological activities, e.g., toxicity, mechanisms of action, pharmacology, and adverse effects, to the structure of molecules. MeSH defines a hierarchy of biological, pharmacological concepts and is linked to some PubChem records. It is desirable to find all molecules linked to the different levels in MeSH and to mine chemical patterns that are common to them. Such common patterns are referred to as pharmacophores, biophores or toxicophores, depending on the activity under consideration.

A superimposition or alignment of 2D and/or 3D structures indicates geometrically conserved patterns. These are alignment-dependent pharmacophores, biophores or toxicophores, as the case might be. The limitation of this approach is that 2d graphs or 3d conformations are required. As the molecules diverge in structure so does the likelihood of obtaining good alignments. Another approach is to find maximum common substructures present in a given class of molecules. Graph-theoretic (Wiener index), topological (rings, atom counts) and physico-chemical properties such as molecular weight, polar surface area, and/or logP are also used. These descriptors are then related with classes of molecules with common activity. The problem common to most of these methods is that using a table to store descriptors loses the hierarchical relationships between the descriptors. Presence or absence of functional groups, atom types and rings is also used as a so-called “fingerprint” and some measure of distance between fingerprints of molecules is used to assess similarities. The similarities are then used for clustering and for inferring commonality of activity.

Thus, there is clearly a basic limitation to the above approaches. Chemists generalize molecules in terms of ring systems, functional groups and atom and bond types. All these concepts, especially functional groups are hierarchical in nature. A fragment common to all molecules might be aliphatic, alkane, etc. Most of the molecules might have a primary alkane fragment, while some others might have a secondary or tertiary alkane. However, conceptually the fragments are similar since they are all alkanes, only differing in specific types. This similarity is missed by fragment-count algorithms that rely on graph-matching techniques. Similarity search algorithms predefine a library of substructures of functional groups, ring systems and atoms and bonds. However, the ‘similarity’ between two molecules is quantified in terms of a mathematically defined distance between vectors of numbers representing them, which again does not delve into the hierarchical nature of domain knowledge. The issue is compounded when considering two connected substructures. While it is desirable to specify the exact molecular graph of the two molecular fragments, the likelihood that this connectivity will be conserved over many molecules in a class is very small. It is far more likely that the connection pattern, e.g., amine, primary amine connected to a carbonyl group, carboxylic acid, will be conserved. Thus, the hierarchical nature of the domain representation can help in identifying extremely specific as well as generic patterns at a higher level of abstraction.

While there have been some attempts to provide the facility of querying structure databases based on functional group and ring system hierarchies, the explicit intention of using optimal common hierarchical patterns to understand biological activity at a wide variety of levels has not been attempted. It is desirable, then, and an object of the invention, to provide improved approaches for automated data mining in the context of finding common, hierarchical patterns.

Some previous automated methods for discovering and/or analyzing structure-activity relationships have used manually-curated rule bases and expert systems, but have been dependent on specialized logic languages for inference. Manually curated rule bases have been in widespread use for several decades now, underscoring the simplicity and effectiveness of knowledge bases. One example is the DEREK for Windows, which has chemical alerts for hepatotoxicity, bacterial mutagenicity, genotoxicity and skin sensitization. In order to create a more efficient and accessible solution, however, there is a need for an approach for automatically generating a robust rule base in a method and system that can be implemented without dependence on specialized logic languages.

There is a need, then, for an improved system that can automate the process of rule discovery for a comprehensive class of activities and its subsequent storage and application to new molecules in the form of an expert system.

### BRIEF SUMMARY OF THE INVENTION

The invention generally provides for transforming two dimensional structural coordinates of a set of chemically, biologically or pharmacologically related molecules to a hierarchical schema of concepts and descriptors. Further, according to the invention, patterns common to all molecules in a given class or clusters of molecules in the class can be extracted and stored, forming rules that relate hierarchical chemical features and concepts to biological, pharmacological or chemical activity. Such patterns can be stored as rules for matching with query molecules, thus indicating potential uses of the query molecules.

The invention further provides for a system and methods that can relate chemical structure to biological and pharmacological activities by transforming molecular structures to a hierarchical representation of chemical concepts and descriptors and detecting common tree like patterns.

Embodiments of the invention further provide for chemical concepts and descriptors such as functional groups, ring systems, atom and bond types and the distances between these entities to be defined in an XML schema, DTD or simple XML file. Sets of molecules belonging to a common pharmacological or biological activity can be referred to as a class or activity class. The XML template file can be used to transform a class of molecules with structural data to an XML file, reflecting the tree like structure of the template.

Embodiment of the invention provide for a query performed on the output XML for a given class to give hierarchical patterns that are common to groups of molecules in the class. These common patterns can form rule sets for the given chemical, biological or pharmacological classification. The patterns can be common to a subset of molecules within a class and can form a sub-cluster of rules. Patterns can also be common at the leaf node of the concept hierarchy or at any previous node. In a preferred embodiment, patterns common to more molecules and reaching terminal nodes are deemed of a higher importance as compared to rules derived from fewer molecules. Similarly, patterns conserved till the terminal nodes are more specific in nature e.g. Primary Alkane, as compared to nodes near the root nodes e.g. Alkane and are thus more valuable in terms of specificity of the rule (refer to the ontolgies). One preferred embodiment provides for an algorithm that can find rules for binary data. A further preferred embodiment provides for an algorithm that can find rules for continuous, binary, one class and multi-class data.

The invention provides further for rules that are generated to be stored in a file system in XML and/or other formats, LDAP directory, relational database and/or a business rules engine, inter alia. According to at least one preferred embodiment, any such collection of rules can be referred to a RuleBase, irrespective of the method of rule storage. Further, the invention provides for inferring rules or patterns that are common to or distinct within any number of different biological classes and subclasses. Internal proprietary databases or public domain databases can form the chemical molecule structure and activity data input.

According to embodiments of the invention, by using the foregoing system and methods, a user can discover all potential classes of activities or confirm an existing hypothesis about a particular activity or class.

A preferred embodiment provides for constructing an integrated knowledge base of rules using all biological and functional classes, as defined in the NCBI MeSH browser (which for example can be accessed at the URL www.nlm.nih.gov/mesh) and using all pharmacological categories, as defined in PubChem (which for example can be accessed at the URL pubchem.ncbi.nlm.nih.gov).

One embodiment of the invention provides for a method for discovering tree-like patterns common to a class of molecules, hereafter called “Rules”, by using molecular functional group, Ring systems and Atom Type concept hierarchies or ontologies. A ‘class’ refers to a set of molecules with common pharmacological, biological or chemical properties. Storage, execution and combination of Rules in groups related by virtue of a common class, in file systems e.g. XML, Rule Engines, LDAP directories and relational databases.

An embodiment further provides for employing the foregoing when the activity classes are arranged in a hierarchy or schema.

One embodiment of the invention provides for a method for clustering molecules on the basis of similarity between molecules as a function of the similarity between similar hierarchical patterns.

One embodiment of the invention provides for employing the above methods to find conserved hierarchical conceptual patterns in clusters of similar molecules rather than all molecules in a given class. Each cluster can lead to different sets of rules.

Employing the foregoing methods, where the Class or the hierarchical concepts or descriptors have discrete and continuous values. Continuous values are discretized by binning into class intervals. The descriptors used (e.g. spectroscopic data), corresponding to different functional groups, rings and atom types are arranged in a hierarchical order.

Another embodiment provides for employing the foregoing methods, where the rule includes any equation between discretized class values and rule nodes and where the parameters of the equation are used for rule induction.

One embodiment of the invention provides for using a particular instance of the output of the above methods or the complete rulebase of the foregoing system and methods according to the invention for inferring all potential activities or confirming a particular activity by forward and backward chaining in a rule engine, or performing Boolean queries on a relational database or similar schema.

A further embodiment provides for finding similarities between connectivities of functional groups, ring systems and atom types conserved in all or clusters of molecules.

An embodiment of the invention provides for finding bioisosteres by enumerating differences between functional groups, rings and atom types in the molecules, in a given class.

An embodiment provides for generating all chemically feasible molecular structures from molecular formulae of known drugs and drug like molecules and using Rulebase obtained from the foregoing methods and system to infer activities.

One embodiment provides for predicting biological activity at a higher biological level, i.e., activity against cell, tissue, organ, system, since drug targets are expressed in physiological states like diseases, symptoms and toxicity and prediction about activities at the drug-target level can be used according to the invention to automatically predict the activity at the higher biological levels.

A further embodiment of the invention provides for new molecular structures that match the rule for a given class to be generated computationally. These molecular structures may be generated using an exhaustive graph theoretic methodology or using any evolutionary method. The invention provides for the generated molecules to always contain the patterns specified by the rules and the molecules may or may not exist previously in nature.

The invention further provides for embodiments of methods and systems wherein the system is programming language, operating system and storage mechanism agnostic. While currently implemented in Java in one preferred embodiment, the system according to various embodiments can be implemented in a wide variety of programming languages, database systems, rule engines, and file systems, so long as the chief features of hierarchical domain knowledge, rule induction and application for many activity classes are followed.

At least one embodiment of the invention provides for separating the process steps for assembling domain knowledge or ontologies, transforming two-dimensional chemical structure data to this ontological form, inferring conserved hierarchical patterns in molecular classes and storage, and applying the rule base using rule engines, lightweight directory access protocol (LDAP), and relational databases.

### BRIEF DESCRIPTION OF THE DRAWINGS

Embodiments of the invention are illustrated in the figures of the accompanying drawings. These figures are merely examples which should not unduly limit the scope of the invention. Persons of ordinary skill in the art can contemplate many alternatives, variations and modifications within the scope of the invention described herein.

FIG. 1A illustrates a system with computer hardware and software according to an embodiment of the invention.

FIG. 1B illustrates database and software components and processing steps according to an embodiment of the invention.

FIG. 2A illustrates an example of system architecture for system a first module according to an embodiment the invention.

FIG. 2B illustrates an example of system architecture for a second module according to an embodiment of the invention.

FIG. 2C illustrates an example of system architecture for a third module according to an embodiment of the invention.

FIG. 2D illustrates an example of system architecture for a fourth module according to an embodiment of the invention.

FIG. 2E illustrates connectivity between the Modules 1-4, according to an embodiment of the invention.

FIG. 3 illustrates a test set of 1233 antibiotics in an exemplary implementation and case study according to one embodiment of the invention.

FIG. 4 illustrates the 53 hits obtained after running the test set against the training set rules in an exemplary implementation and case study according to one embodiment of the invention.

FIG. 5 illustrates the 35 hits cross checked for toxicity in an exemplary implementation and case study according to one embodiment of the invention.

### DETAILED DESCRIPTION OF SPECIFIC EMBODIMENTS

A preferred embodiment of the invention provides for system and methods for automating molecular mining and biological activity prediction, using XML schema, XML queries, rule inference and Rule Engines, wherein chemical structure can be related to biological and pharmacological activities by transforming molecular structures to a hierarchical representation of chemical concepts and descriptors (such as, for example, deriving a functional group schema for a set of molecules), building an XML file that is similar to the functional group schema, discovering causal links between functional groups or other ontologies and biological activity by detecting common tree-like patterns, creating a Rule Base of biological activities and functional group rules by based on the causal links, automating prediction of likely bioactivity of new molecules using a Rule Engine, RDBMS, and XML/XQuery together with the Rule Base, and generating constitutional isomers that have the same functional groups for a given biological activity. The invention can be further illustrated by the additional detailed descriptions of preferred embodiments provided below and by way of specific examples of software code components used to implement a preferred embodiment of the system and methods.

A preferred embodiment provides for working between node levels of the hierarchical tree-based description of the chemical structure of a molecule, where SAR relationships that pertain to different levels are being mined from the database and applied to the similarity data-mining and rule inference, so that rule development is based on more “relational” information (e.g., internal relationships, or relationships between internal molecular structure), rather than on simply strings, weighted strings or matrices of key fragments or descriptors.

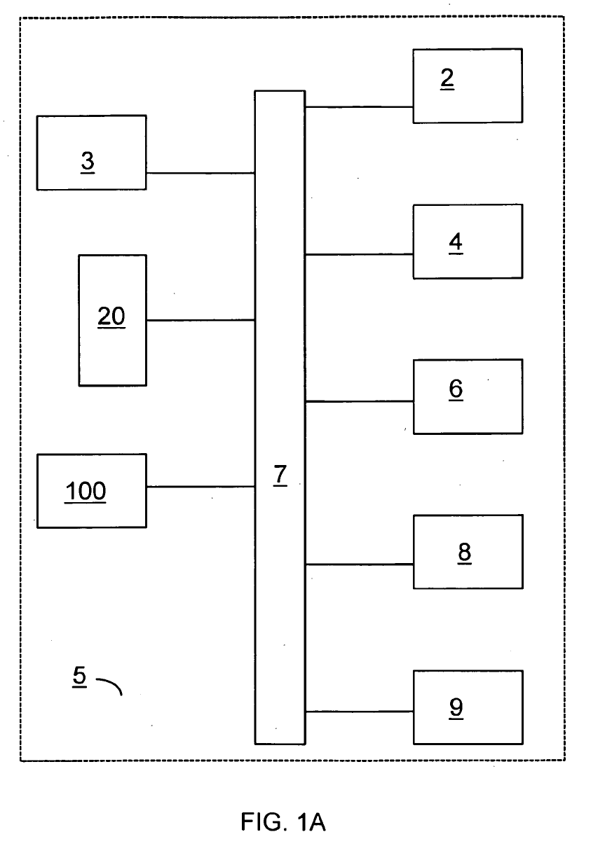

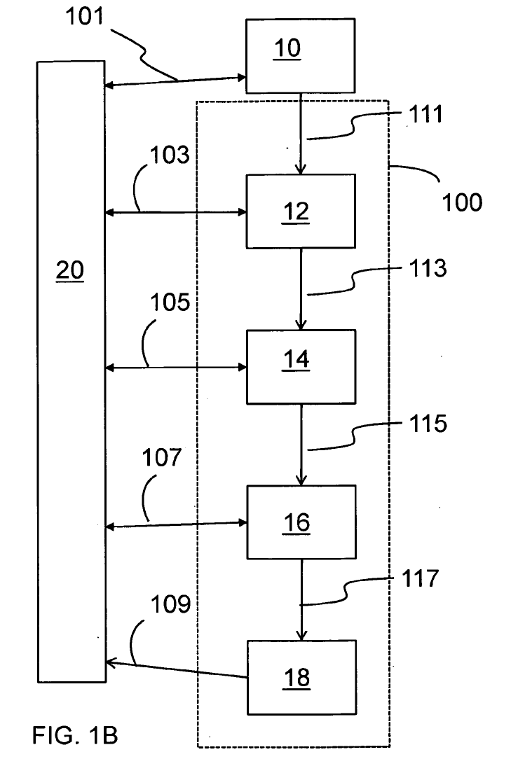

Referring to FIG. 1A, a preferred embodiment can provide for a computational system 5 comprised of computer hardware and software, more particularly a central processing unit 2, memory 4, graphic user interface 6, such as, for example, a computer monitor, a user input device 8, such as, for example, a keyboard, a mouse or other input device, computer bus 7, storage device(s) 9, such as hard disks, removable disks, network storage, or other storage devices, external data connectivity 3, such as, for example, Internet, Web, local area network, wide-area network, database 20, and software modules 100. Software 100 can include operating system software that can be stored on storage device 9 and loaded into computer memory 4 to control operation of the processor and to direct data within the system and to control other software modules. Software 100 can include other software modules according to embodiments of the invention as will be described below. It will be appreciated that software 100 can be distributed in multiple locations within and without the system 5, such as distributed on external servers reachable through LAN and/or the Internet. It will be appreciated that the bus 7 can be wires and/or a combination of wire and wireless connectivity. Software 100 can include modules that can bring data from external data sources 3 and store them as part of database 20. It will be appreciated, therefore, that in various preferred embodiments database 20 can be considered to include data sources 3. Database 20 can be stored in any manner of storage device 9 and/or can remain as distributed data stored in many locations and forms locally, or on removable media, or accessible through wired or wireless connections via the Internet, via satellite or other telephony signal.

For one preferred embodiment of the invention, FIG. 1B illustrates some aspects of the interrelationship of system components, such as software 100 and database 20 with program software modules according to the invention and some of the method steps associated with the software operations. For example, software 100 can include rule induction engine 12, Rule Base (or Knowledge Base) 14, rule application engine 16 and output results 18, such as, for example, a resulting output of molecules with predicted activities. Input 10 can be an ontology and can further comprise an XML template. Input 10 can be stored in a database, such as database 20, which can include storage in distributed fashion accessible via the Internet. Database 20 can include a relational database, or a RDBMS, filesystems, Internet or other sources and can include molecular structures, molecular activity data, biological data, biological activity data (or bioactivity data).

It will be appreciated that the terms “activity”, “biological activity” and/or “bioactivity” are used in this specification to describe any one or more aspects of the full range of pharmacological interactions, including pharmacokinetic activities and/or pharmacodynamic activities, and without limitation including adsorption, rate of distribution, volume of distribution, metabolism, excretion, half-life, receptor binding activity, receptor binding inhibition, specific and/or non-specific activities, specificity, toxicity, signaling disruption, modulation or mediation, and further including the movement, change, effect or other response, or lack thereof, of any one or more of the full range of biological constituents and biological processes, including, without limitation, DNA, RNA, genes, chromosones, proteins, nuclei, mitochondria, cytoplasm, cell walls, biological pathways, cells, tissues, organs, enzymes, metabolism, serum, whole organisms, physiological state, degree of health, therapeutic index or margin, and any other aspect of biological structure, interaction and/or response.

Still referring to FIG. 1B, database 20 can include any one or more of a full range of chemical and/or molecular descriptors, or chemical descriptive information, or parameters relating to characteristics of chemicals and/or molecules, relating to molecular structure and physical aspects of molecules, including, without limitation, number of atoms, type of atoms, atomic number, atomic weights, atomic relationships, electronegativity, excitation levels, valence state, activation information, atomic physics parameters, field strengths, total energy, enthalpy, electronic energy, heat of formation, entropy, repulsion energies, attraction energies, resonance characteristics, electrostatic characteristics, electron kinetic energy densities, energies of protonation, bonds, number of bonds, bond types, bond distances, bond angles, bond strengths, rings, ring structures, rotational stability, molecular wobble, molecular vibration, relative angles between ring planes, chirality, vertex properties, molecular parts, number of terminal atoms, functional groups, ligands, isomer characteristics, molecular size, molecular weight, molecular chain characteristics, molecular orientation, topology, substructural relationships, 2-dimensional structural formulae, 2-dimensional descriptive elements and/or 3-dimensional descriptive elements, stereochemistry, and/or any number of other types of information describing chemicals and/or molecules. Additionally, database 20 can include any one of more of a full range of descriptors relating to chemical and/or molecular reactivity, interactivity and/or other aspects of physical chemical relationship between one molecule and another molecule, or between one molecule and many other similar or different molecules, or between one group of many molecules and another group of many molecules of the same or different type, including, without limitation, electrochemical interactions, absorption, dissolution, repulsion, binding coefficient, specific activity, binding strength, crystallization parameters, melting point, molecular stability, association, dissociation, activity coefficients, activity constants, dissociation constants, pK, pKa, any number of chemical reactivity rate constants, density, solubility, and/or viscosity, inter alia.

Continuing to refer to FIG. 1B, at step 111 the rule induction engine 12 reads in data from input source 10, which can include XML template/ontology and at step 103 reads data from database source 20, which can include molecular structure and activity data. Processing within the rule induction engine can include, for example, without limitation, transformation steps, compound clustering steps, pattern-discovery steps, constraint adjustment steps and rule validation steps. At step 113 the rule induction engine 12 outputs a set of rules to a Rule Base 14 (which can also be termed a Knowledge Base). At step 105 the Rule Base can be written, stored and otherwise maintained and/or manipulated in the database 20. At step 115 the Rule Application Engine 16 addresses or reads from the Rule Base 14. Additionally, at step 107 the Rule Application engine 16 acquires from database source 20 ontology data related to molecular structure (such as, for example, XML Ontology including functional groups, ring systems, atom types) and a target set of molecular structures with unknown Activity Class Data, which can come from flat files, RDBMS, the Web and/or LDAP sources. The rule application engine 16 can perform, without limitation, steps such as predicting activity classes of unknown molecules and generating, based on constraints, new molecular structures using different scaffolds that can be predicted to have certain bioactivities. At step 117 the Rule Application engine 16 outputs the results 18, and at step 109 the results can be stored in the database 20, which as noted above, can include distributed storage on the Internet, so that step 109 can include transmitting results to any number of a variety of destinations on the Internet for storage and/or further operations. Results 18 can include, without limitation, results of activity class prediction and/or new molecular structures with predicted bioactivities.

It will be appreciated that the interconnectivity of the hardware and software modules depicted in FIG. 1A and FIG. 1B allow for ongoing, iterative processing, which can include machine learning, whereby writing of results into database 20 allows new information to be made available to the ontology source 10, the rule induction engine 12, the Rule Base 14 and to the Rule Application engine 16 in immediately subsequent cycles of processing.

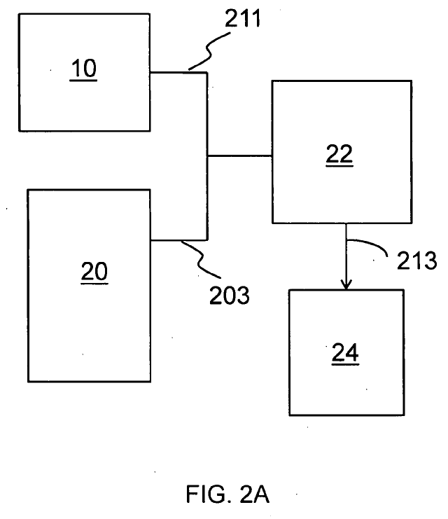

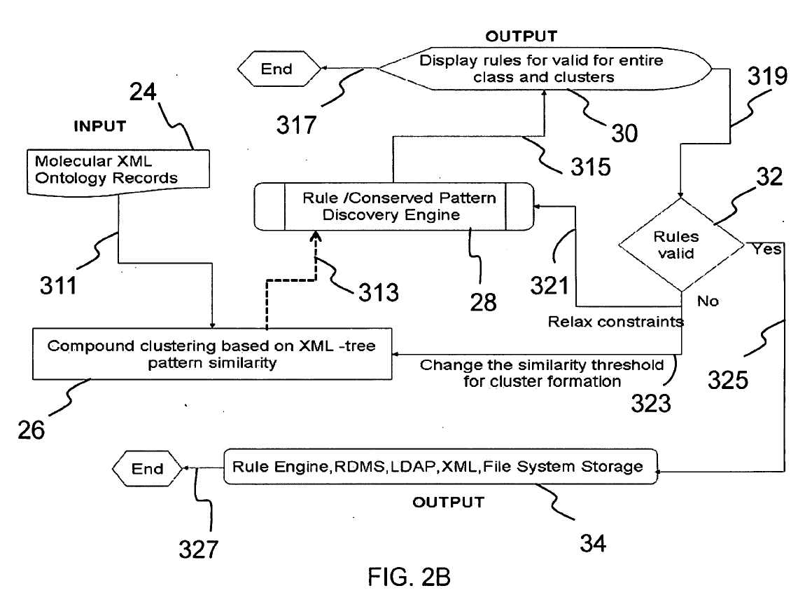

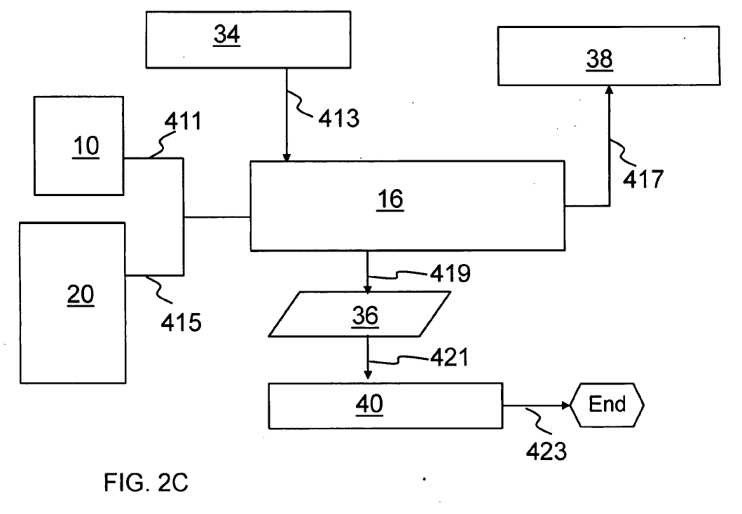

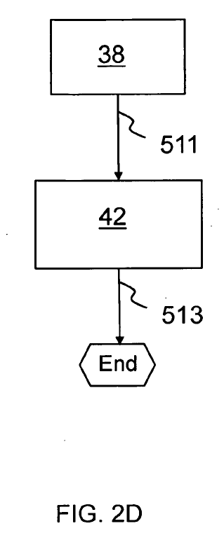

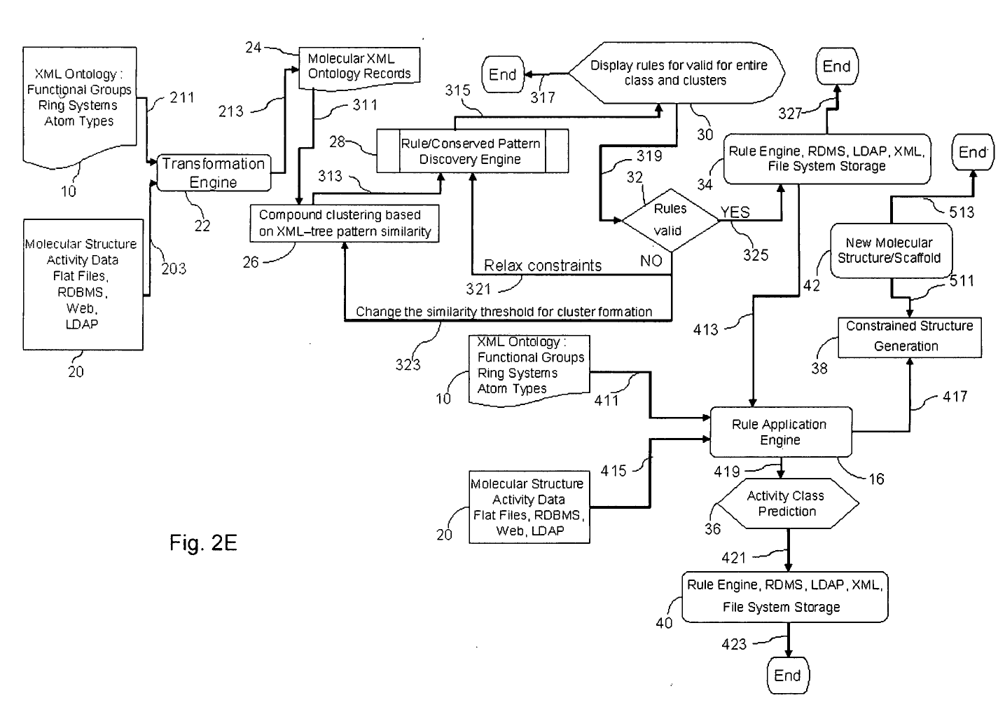

The architecture of a further preferred embodiment of the invention can have several distinct modules. For example, FIG. 2A illustrates a system architecture and processes of a first system module, according to an embodiment of the invention. Referring to FIG. 2A, in one preferred embodiment, an input data file 10, such as, for example an XML ontology, can contain structural or other characteristic information about molecules, such as, for example, functional groups, ring systems and atom types, inter alia. A further source of input data 20 can include, by way of example and without limitation, molecular structure activity data, flat files, relational database management system (RDBMS), network data sources (e.g., Internet and/or World Wide Web), and/or LDAP. Input data 10 is read at step 211 and further source of input data 20 is read at step 203 as inputs to transformation engine 22, which transforms the data and produces at step 213 output data record(s) 24, which can be, for example, molecular XML ontology records. Note that data input step 211 and step 203 depicted in FIG. 1B for an embodiment can correspond closely with data input step 111 and step 103, respectively, depicted in FIG. 2A for an embodiment of the invention.

FIG. 2B illustrates system architecture and processes of a second module, according to an embodiment of the invention. At step 311 data records 24 are read into a clustering engine 26, which can perform compound clustering based on pattern similarity, such as, for example, based on similar patterns seen in the hierarchical XML-tree structures. The procedure progresses at step 313 to include operation of a rule/conserved pattern discovery engine 28. At step 315 the Rule/Conserved Pattern Discovery Engine 28 can output to an output record 30, which can include, for example, outputs that display valid rules for entire class and individual clusters therein. If sufficient valid rules are generated for an entire class and cluster, then the process reaches END step 317. If a sufficient set of valid rules is not generated, then the process can continue in step 319. In the rule validation component 32 rules are deemed non-trivial or valid if they contain at least three distinct nodes, e.g., in a case of function groups, an alkane, aromatic ring and carbonyl group would be three distinct nodes. If the rules are not valid, then the system can either relax the constraints and in step 321, pass the process back to the Discovery Engine 28 or in step 323 change the similarity threshold for cluster formation and pass the process back to the clustering engine 26 to update clustering. The criterion for reclustering is that a valid rule must be found for every cluster of molecules for the given class and the number of singletons should be minimal. The number of singletons is a user defined criteria. If the Rules are valid, then the rule validation process can continue at step 325 to output the result to an output record 34, which can include, for example, an output record in the form of an addition to a Rule Base stored in or associated with a Rule Engine, RDMS, LDAP, and/or File System Storage. Note that step 325 and output 34 depicted in FIG. 2B for an embodiment of the invention can correspond closely with step 113 and Rule Base 14, respectively, depicted in FIG. 1B for an embodiment of the invention. After writing output to a file and/or Rule Base accessible to a Rule Engine, the process of this second module can end in step 327.

FIG. 2C illustrates a system architecture and processes of a third module system, according to an embodiment of the invention. The Rule Application Engine 16 can acquire at step 411 input data 10, which can include, for example, without limitation, XML ontology comprising functional groups, ring systems, atom types and/or other chemical descriptors, and can further acquire data from data storage 34 at data input step 413, which can include, for example, without limitation, data from rule-engine storage, Rule Base, RDBMS, LDAP, XML and/or file system storage. Further, data 34 depicted in FIG. 2C can be the same, in various embodiments of the invention, as the data result 34 from the second module depicted in FIG. 2B. Continuing to refer to FIG. 2C, the Rule Application Engine 16 can further acquire, at step 415, additional data from a further source of input data 20, which can include, for example, without limitation, molecular structure activity data, flat files, relational database management system (RDBMS), network data sources (e.g., Internet and/or World Wide Web), and/or LDAP. At step 419 the Rule Application Engine 16 can pass data to an Activity Class Prediction component 36 which can output at step 421 an output result 40, which can include, without limitation, predicted activity classes that can be stored in a Rule Engine, Rule Base, RDBMS, LDAP, XML and/or file system storage, whereupon at step 423 this process path can end. Additionally, the Rule Application Engine 16 can proceed through step 417 to generate constitutional isomers of the training set molecules or the test set molecules at output 38 and the rule engine 16 can then apply a further step 511 (see FIG. 2D) to select isomers constrained to follow specific rules related to a class. Since the functional groups are the same but structure changes completely, new structures that may be not found in nature can be found by scaffold-hopping as an output result 42. The following example shows an input molecule in SMILES format that has anti-asthmatic activity. This is only one of the molecules from a set of anti-asthamatic molecules cited earlier in the document:
O(CCCCc1ccccc1)c1ccc(cc1)C(═O)Nc1cc2oc(cc(═O)c2cc1)c1n[nH]nn1

The Constitutional isomer generation code then rearranges connections between atoms and bonds of the molecule to generate constitution isomers i.e. molecules with same molecular formula but different structures. The output is 50 molecular structures as follows:
C═C1C═C(C═C1)CCCCOc1ccc(cc1)C(═O)Nc1ccc2c(═O)cc(oc2c1)C1N═NNN1
c1cccc(c1)CCCCOc1ccc(cc1)C(═O)Nc1ccc2c(═O)cc(oc2c1)C1N═NNN1
C═CC1═C(C═C1)CCCCOc1ccc(cc1)C(═O)Nc1ccc2c(═O)cc(oc2c1)C1N═NNN1
C1═CC2C1(C═C2)CCCCOc1ccc(cc1)C(═O)Nc1ccc2c(═O)cc(oc2c1)C1N═NNN1
c1ccc(CCCCOc2ccc(cc2)C(═O)Nc2ccc3c(═O)cc(oc3c2)C2N═NNN2)cc1
C(═C/C═C1/C═C1)/CCCCOc1ccc(cc1)C(═O)Nc1ccc2c(═O)cc(oc2c1)C1N═NNN1
C═C/C═C(/C#C)CCCCOc1ccc(cc1)C(═O)Nc1ccc2c(═O)cc(oc2c1)C1N═NNN1
c1cccc(c1)CCCCOc1ccc(cc1)C(═O)Nc1ccc2c(═O)cc(oc2c1)C1N═NNN1
C1═CC═C2C(C12)CCCCOc1ccc(cc1)C(═O)Nc1ccc2c(═O)cc(oc2c1)C1N═NNN1
c1ccccc1CCCCOc1ccc(cc1)C(═O)Nc1ccc2c(═O)cc(oc2c1)C1N═NNN1
c1ccc(cc1)CCCCO\C═C1C═C(C═C1)C(═O)Nc1ccc2c(═O)cc(oc2c1)C1N═NNN1
c1ccc(cc1)CCCCOc1cccc(c1)C(═O)Nc1ccc2c(═O)cc(oc2c1)C1N═NNN1
c1ccc(cc1)CCCCO\C═CC1═C(C═C1)C(═O)Nc1ccc2c(═O)cc(oc1c1)C1N═NNN1
c1ccc(cc1)CCCCOC1═CC2C1(C═C2)C(═O)Nc1ccc2c(═O)cc(oc2c1)C1N═NNN1
c1ccc(cc1)CCCCOc1ccc(C(═O)Nc2ccc3c(═O)cc(oc3c2)C2N═NNN2)cc1
c1ccc(cc1)CCCCO\C(═C\C═C1\C═C1)C(═O)Nc1ccc2c(═O)cc(oc2c1)C1N═NNN1
c1ccc(cc1)CCCCO\C═C\C═C(\C#C)C(═O)Nc1ccc2c(═O)cc(oc2c1)C1N═NNN1
c1ccc(cc1)CCCCOc1cccc(c1)C(═O)Nc1ccc2c(═O)cc(oc2c1)C1N═NNN1
c1ccc(cc1)CCCCOC1═CC═C2C(C12)C(═O)Nc1ccc2c(═O)cc(oc2c1)C1N═NNN1
c1ccc(cc1)CCCCOc1ccccc1C(═O)Nc1ccc2c(═O)cc(oc2c1)C1N═NNN1
c1ccc(cc1)CCCCOc1ccc(cc1)C(═O)NC1C2═Cc3c(═O)cc(oc3C12)C1N═NNN1
c1ccc(cc1)CCCCOc1ccc(cc1)C(═O)NC12C3C2c2c(═O)cc(oc2C13)C1N═NNN1
c1ccc(cc1)CCCCOc1ccc(cc1)C(═O)Nc1ccc2oc(cc(c2c1)═O)C1N═NNN1
c1ccc(cc1)CCCCOc1ccc(cc1)C(═O)NC1C═C2c3c(═O)cc(oc3C12)C1N═NNN1
c1ccc(cc1)CCCCOc1ccc(cc1)C(═O)NC12C═CC1c1oc(cc(c21)═O)C1N═NNN1
c1ccc(cc1)CCCCOc1ccc(cc1)C(═O)NC12C═CC3═C(OC(═CC2═O)C2N═NNN2)C13
c1ccc(cc1)CCCCOc1ccc(cc1)C(═O)NC12C═CC34C(═O)C═C(OC23C14)C1N═NNN1
c1ccc(cc1)CCCCOc1ccc(cc1)C(═O)Nc1ccc2C(═O)C═C(Oc1c2)C1N═NNN1
c1ccc(cc1)CCCCOc1ccc(cc1)C(═O)NC12C═CC═3C4(O2)C═C(OC3C14)C1N═NNN1
c1ccc(cc1)CCCCOc1ccc(cc1)C(═O)NC(/C═C/C═1C═2C═C(OC1C2)C1N═NNN1)═O
c1ccc(cc1)CCCCOc1ccc(cc1)C(═O)NC12C═CC═3C(═O)C1C3OC(═C2)C1N═NNN1
c1ccc(cc1)CCCCOc1ccc(cc1)C(═O)NC1C═Cc2c(═O)c3c(oc2C13)C1N═NNN1
c1ccc(cc1)CCCCOc1ccc(cc1)C(═O)NC12C═CC═3C(═O)C4C2(OC3C14)C1N═NNN1
c1ccc(cc1)CCCCOc1ccc(cc1)C(═O)Nc1ccc═2c(═O)ccc2oc1C1N═NNN1
c1ccc(cc1)CCCCOc1ccc(cc1)C(═O)NC12C═CC═3C(═O)C═C(C4N═NNN4)C1C3O2
c1ccc(cc1)CCCCOc1ccc(cc1)C(═O)NC1(C═Cc2c(═O)cc3oc2C13)C1N═NNN1
c1ccc(cc1)CCCCOc1ccc(cc1)C(═O)NC12C═CC═3C(═O)C═C(OC1C23)C1N═NNN1
c1ccc(cc1)CCCCOc1ccc(cc1)C(═O)NC═1C═CC23C4(O3)C═C(OC24C1)C1N═NNN1
c1ccc(cc1)CCCCOc1ccc(cc1)C(═O)Nc1ccc(c2cc(oc2c1)C1N═NNN1)═O
c1ccc(cc1)CCCCOc1ccc(cc1)C(═O)NC═1C═CC23C(═O)C2(OC(═C3)C2N═NNN2)C1
c1ccc(cc1)CCCCOc1ccc(cc1)C(═O)NC═1C═CC2C(═O)C3═C(OC23C1)C1N═NNN1
c1ccc(cc1)CCCCOc1ccc(cc1)C(═O)NC═1C═CC23C(═O)C4C3(OC24C1)C1N═NNN1
c1ccc(cc1)CCCCOc1ccc(cc1)C(═O)NC═1C═Cc2c(═O)cc(oc2C2N═NNN2)C1
c1ccc(cc1)CCCCOc1ccc(cc1)C(═O)NC═1C═CC23C(═O)C═C(C4N═NNN4)C2(O3)C1
c1ccc(cc1)CCCCOc1ccc(cc1)C(═O)NC═1C═CC2(C(═O)C═C3OC23C1)C1N═NNN1
c1ccc(cc1)CCCCOc1ccc(cc1)C(═O)Nc1ccc2C(═O)C═C(OC3N═NNN3)c2c1
c1ccc(cc1)CCCCOc1ccc(cc1)C(═O)NC═1C═Cc2c(═O)cc(oc2C2N═NNN2)C1
c1ccc(cc1)CCCCOc1ccc(cc1)C(═O)Nc1ccc2c(═O)ccoc2c1C1N═NNN1
c1ccc(cc1)CCCCOc1ccc(cc1)C(═O)Nc1ccc2c(═O)cc(oc2c1)C1N2N1NN2
c1ccc(cc1)CCCCOc1ccc(cc1)C(═O)Nc1ccc2c(═O)cc(oc2c1)C1N═NNN1

Owing to rearrangement of the atoms and bonds, the core structure is changed or the scaffold is hopped. Now rules that were generated for anti-asthmatic molecules and stored in the rule engine or filesystem are applied to these isomers to select only those isomers that satisfy criteria of functional group conservation for anti-asthmatic activity. The output of this step, in this example, is 42 structures from 50 structures above:
C═C1C═C(C═C1)CCCCOc1ccc(cc1)C(═O)Nc1ccc2c(═O)cc(oc2c1)C1N═NNN1
c1cccc(c1)CCCCOc1ccc(cc1)C(═O)Nc1ccc2c(═O)cc(oc2c1)C1N═NNN1
C═CC1═C(C═C1)CCCCOc1ccc(cc1)C(═O)Nc1ccc2c(═O)cc(oc2c1)C1N═NNN1
C1═CC2C1(C═C2)CCCCOc1ccc(cc1)C(═O)Nc1ccc2c(═O)cc(oc2c1)C1N═NNN1
c1ccc(CCCCOc2ccc(cc2)C(═O)Nc2ccc3c(═O)cc(oc3c2)C2N═NNN2)cc1
C(═C/C═C1/C═C1)/CCCCOc1ccc(cc1)C(═O)Nc1ccc2c(═O)cc(oc2c1)C1N═NNN1
C═C/C═C(/C#C)CCCCOc1ccc(cc1)C(═O)Nc1ccc2c(═O)cc(oc2c1)C1N═NNN1
c1cccc(c1)CCCCOc1ccc(cc1)C(═O)Nc1ccc2c(═O)cc(oc2c1)C1N═NNN1
C1═CC═C2C(C12)CCCCOc1ccc(cc1)C(═O)Nc1ccc2c(═O)cc(oc2c1)C1N═NNN1
c1ccccc1CCCCOc1ccc(cc1)C(═O)Nc1ccc2c(═O)cc(oc2c1)C1N═NNN1
c1ccc(cc1)CCCCOC═C1C═C(C═C1)C(═O)Nc1ccc2c(═O)cc(oc2c1)C1N═NNN1
c1ccc(cc1)CCCCOc1cccc(c1)C(═O)Nc1ccc2c(═O)cc(oc2c1)C1N═NNN1
c1ccc(cc1)CCCCOC═CC1═C(C═C1)C(═O)Nc1ccc2c(═O)cc(oc2c1)C1N═NNN1
c1ccc(cc1)CCCCOC1═CC2C1(C═C2)C(═O)Nc1ccc2c(═O)cc(oc2c1)C1N═NNN1
c1ccc(cc1)CCCCOc1ccc(C(═O)Nc2ccc3c(═O)cc(oc3c2)C2N═NNN2)cc1
c1ccc(cc1)CCCCO\C(═C\C═C1\C═C1)C(═O)Nc1ccc2c(═O)cc(oc2c1)C1N═NNN1
c1ccc(cc1)CCCCO\C═C\C═C(\C#C)C(═O)Nc1ccc2c(═O)cc(oc2c1)C1N═NNN1
c1ccc(cc1)CCCCOc1cccc(c1)C(═O)Nc1ccc2c(═O)cc(oc2c1)C1N═NNN1
c1ccc(cc1)CCCCOC1═CC═C2C(C12)C(═O)Nc1ccc2c(═O)cc(oc2c1)C1N═NNN1
c1ccc(cc1)CCCCOc1ccccc1C(═O)Nc1ccc2c(═O)cc(oc2c1)C1N═NNN1
c1ccc(cc1)CCCCOc1ccc(cc1)C(═O)NC1C2═Cc3c(═O)cc(oc3C12)C1N═NNN1
c1ccc(cc1)CCCCOc1ccc(cc1)C(═O)NC12C3C2c2c(═O)cc(oc2C13)C1N═NNN1
c1ccc(cc1)CCCCOc1ccc(cc1)C(═O)Nc1ccc2oc(cc(c2c1)═O)C1N═NNN1
c1ccc(cc1)CCCCOc1ccc(cc1)C(═O)NC1C═C2c3c(═O)cc(oc3C12)C1N═NNN1
c1ccc(cc1)CCCCOc1ccc(cc1)C(═O)NC12C═CC1c1oc(cc(c21)═O)C1N═NNN1
c1ccc(cc1)CCCCOc1ccc(cc1)C(═O)NC12C═CC34C(═O)C═C(OC23C14)C1N═NNN1
c1ccc(cc1)CCCCOc1ccc(cc1)C(═O)Nc1ccc2C(═O)C═C(Oc1c2)C1N═NNN1
c1ccc(cc1)CCCCOc1ccc(cc1)C(═O)NC1C═Cc2c(═O)c3c(oc2C13)C1N═NNN1
c1ccc(cc1)CCCCOc1ccc(cc1)C(═O)NC12C═CC═3C(═O)C4C2(OC3C14)C1N═NNN1
c1ccc(cc1)CCCCOc1ccc(cc1)C(═O)Nc1ccc═2c(═O)ccc2oc1C1N═NNN1
c1ccc(cc1)CCCCOc1ccc(cc1)C(═O)NC12C═CC═3C(═O)C═C(C4N═NNN4)C1C3O2
c1ccc(cc1)CCCCOc1ccc(cc1)C(═O)NC1(C═Cc2c(═O)cc3oc2C13)C1N═NNN1
c1ccc(cc1)CCCCOc1ccc(cc1)C(═O)Nc1ccc(c2cc(oc2c1)C1N═NNN1)═O
c1ccc(cc1)CCCCOc1ccc(cc1)C(═O)NC═1C═CC23C(═O)C2(OC(═C3)C2N═NNN2)C1
c1ccc(cc1)CCCCOc1ccc(cc1)C(═O)NC═1C═CC2C(═O)C3═C(OC23C1)C1N═NNN1
c1ccc(cc1)CCCCOc1ccc(cc1)C(═O)NC═1C═CC23C(═O)C4C3(OC24C1)C1N═NNN1
c1ccc(cc1)CCCCOc1ccc(cc1)C(═O)NC═1C═Cc2c(═O)cc(oc2C2N═NNN2)C1
c1ccc(cc1)CCCCOc1ccc(cc1)C(═O)Nc1ccc2C(═O)C═C(OC3N═NNN3)c2c1
c1ccc(cc1)CCCCOc1ccc(cc1)C(═O)NC═1C═Cc2c(═O)cc(oc2C2N═NNN2)C1
c1ccc(cc1)CCCCOc1ccc(cc1)C(═O)Nc1ccc2c(═O)ccoc2c1C1N═NNN1
c1ccc(cc1)CCCCOc1ccc(cc1)C(═O)Nc1ccc2c(═O)cc(oc2c1)C1N2N1NN2
c1ccc(cc1)CCCCOc1ccc(cc1)C(═O)Nc1ccc2c(═O)cc(oc2c1)C1N═NNN1

Thus molecules that are structural isomers and also follow rules for anti-asthmatic bioactivity are generated. This illustrates the functionality of the constrained molecular generator in a preferred embodiment. Another way to achieve the same would be to modify the isomer generation routine to directly generate only those molecules that have the required functional group patterns. This functionality is very important in drug discovery: to obtain molecules that are bioactive and yet sufficiently different structurally from patented molecular structures; therefore, the software system and methods of the invention provide a substantial advantage to researchers and the economics of drug discovery.

FIG. 2D illustrates a system architecture and processes of a fourth module system, according to an embodiment of the invention. Constrained structures 38, which can be generated as output from a rule application engine can provide input to a program component 42 that creates constitutional isomer two dimensional structures for one or more new molecular structures based on the constraints, which new structures can have different scaffolds. When the New Molecular Structure/Scaffold component 42 has completed then the process can end at step 513.

FIG. 2E illustrates connectivity between the four modules described above in FIGS. 1A-1D, wherein the numbered elements and steps have the same meaning between the figures, such that the corresponding description from FIGS. 1A-1D is incorporated here by reference for description of FIG. 2E.

The system according to a preferred embodiment can run on any modern 32-BIT or 64-BIT computer. Preferably the computing system can run Java™ 1.5 or higher. Preferably, the system has at least 512 MB of RAM. According to one preferred embodiment, additional features of the system can include:

(a) XML schema/DTD/XML, to represent chemical concept hierarchies such as functional groups, rings, atomic types and their interconnections;

(b) An xpath/xquery/xml transformation engine that translates molecular structures to xml records, using the schema from system component (a), above;

(c) A clustering engine to cluster subsets of molecules based on similarity of their schema. This enables better rule discovery since only similar molecules are used for rule discovery;

(d) An xml/xpath/xquery conserved pattern or rule discovery engine to find hierarchical patterns, common to a class or cluster of molecules. A rule module, to insert common patterns as WHEN . . . THEN or IF . . . THEN rule sets into a rule engine or relational database;

(e) Manual or automated validation of rules based on external information or user expertise;

(f) A rule base or knowledgebase;

(g) A Rule application engine, to predict potential activity classes for new molecules in proprietary and public databases, based on rules in the knowledge base; and/or

(h) Constrained Molecular structure generation based on rules for activity class.

A preferred embodiment of the invention does not use logic languages to facilitate the data representation, transformation and rule induction.

A set of molecules with 2D structural information belonging to a particular activity class, can form an input to a system according to one embodiment. This input can be a file, a query to an online/local database or to a web service or rss feed, or the parsed information from a web query, among other sources. The class is generally nominal, such as, for example, anti-cancer, hepatotoxic, or other bioactivity. Numerical but discrete classes can be transformed to nominal ones by defining intervals and allocating a class name to each interval.

SDF, MOL2, SMILES, XYZ, CML and other widely used molecular formats can be used, so long as the two-dimensional connectivity information about atoms and bonds is present or can be reconstructed.

According to various embodiments, there is no particular requirement for any of the modules to be in the client, middleware or server part of a computing system and/or network. Depending on the implementation, the various modules can occur in different places in the system. As a general practice, the more computationally intensive modules described in the examples herein are preferably implemented on the server side. The client part of the system can generally deals with input/output and sketching the molecules for entry into the system.

Few examples according to embodiments of the present invention are herein described. For example, a file with certain number of molecules exhibiting certain property (e.g., anti-asthmatic molecules) can be read in.

XML Chemical Schema: XML templates defined in simple XML files, XML schema or XML DTD for functional groups, ring systems/types and atomic types and other chemical representations can be defined. These template schemas can be extended to form ontologies, although it is not strictly necessary. The schema is such that the primary nodes represent a very generic concept and the terminal leaf nodes represent very specific concepts for a given general concept/descriptor. For example, “carbonyl functional group” is a general concept or descriptor but the terminal nodes such as “aldehyde” and/or “ketone” are more specific. Another example is that of a ring system, which has a single ring at a general level, but nodes near the terminal node that are more specific in terms of chemistry indicate that it is a heterocylic, aromatic ring of degree six.

Other than the schema for rings, functional groups and atom types, the neighborhood schema specifies the output format for representing connections between these entities. The connections can be between similar types or different types of entities e.g. between similar or different functional groups, rings and atom types and combinations thereof. The least number of bonds or the shortest path between two entities is defined as the neighborhood distance between the entities.

Generally, functional groups of the same general type, e.g., aliphatic alkanes occur multiple times in molecules. In this case, all the multiple instances in all molecules are tracked.

The functional group, Ring system and Atom type ontologies can be dynamic and incorporate advances and rearrangements in domain knowledge. The SMARTS chemical pattern language can be used to define functional groups, rings and atom types. This information is used to find presence or absence of these entities in the input molecules.

The functional group ontology is used in this example, although other ontologies for atom types and rings can be implemented according to further embodiments of the invention.

Similarly, an atom type hierarchy can be defined in a schema with information about the organic, inorganic, metallic, hydrogen bond donor acceptor, electronegative character of the atoms.

The ontologies can be extended at a later date by adding nodes e.g. grouping current functional groups into basic, hydrophobic, acidic.

Finally, an XML schema can be defined that is a template to store information regarding intra- and inter-connections between all the above types. Information regarding what is connected to what, such as, for example, a functional group to a particular ring (e.g., a hydroxyl group connected to a heterocycle) and the least distance between them in terms of the number of bonds is also stored separately.

Transformation Engine: Xquery, Xpath query languages and XML parsers in various programming languages can all be employed on the schema templates and input structure file for a given class of molecules. The transformation engine is first used to dynamically find the node names and associated descriptors to be calculated at each node and the means to calculate them. A change in the schema therefore does not inordinately affect the transformation engine. These descriptor calculations (e.g., to find general and specific functional groups) are then performed for all molecular structures in the input.

An output XML file is generated, with a tree structure similar to the schema template but with number of records equal to number of molecules. SMARTS strings are defined in the template xml schema file. These SMARTS strings are used to find presence or absence of particular functional groups, rings and atoms. In case of ring systems, graph-theoretic methods are used to infer ring types, such as single, fused, spiro and bridged rings. Similarly, the heterocylic or carbocylic nature of rings can also be calculated.

The value returned for descriptors that reflect chemical concepts in Boolean-true/false indicates the presence or absence of the entity. The count of child elements in the schema for any given molecule is directly proportional to the count of the parent.

A preferred embodiment of the invention provides for a system that has and methods that use at least one of an XQuery parser, an XML schema/ontology parser and a XQuery/XML parser. More preferably, the system has and methods use at least a combination of XQuery and XML schema/ontology parsers, a combination of XQuery and XQuery/XML parsers and/or a combination of XML schema/ontology and XQuery/XML parsers. Most preferably, the system has and the methods use a combination of XQuery parser(s) and XML schema/ontology parser(s) and XQuery/XML parser(s).

Clustering Engine: Referring now to Module 2, (see FIG. 2B), a preferred embodiment provides for a clustering engine. The central idea in this embodiment is to find hierarchical patterns that are similar in sets of molecules. This approach works quite well for molecules that are not always very similar; but, when they are extremely dissimilar, it tends to produce patterns representative of singletons rather than a cluster of molecules. In general, however, the similarity using functional group and ring systems will cluster molecules better than substructure descriptors that rely on exact subgraph matching. The clustering engine improves the chances of finding significant conserved patterns by clubbing together molecules with a high percentage of similar primary nodes. Primary nodes in case of the functional group schema are the main functional groups. Such an approach is particularly important for diverse molecules that cause various toxic effects. These molecules may be aromatic or non-aromatic, cyclic or straight chain, and differ widely in their structure. The clustering algorithm initially matches the number of primary nodes that are true and false in all molecules. Various similarity coefficients based on the number of matching ‘True’ & ‘False’ nodes can then be defined. One such simple coefficient is a coefficient of molecular similarity based on schema, which is calculated as the following ratio: “TOTAL number of ‘True’ primary node matches in both molecules” divided by “MAXIMUM number of ‘True’ primary node values in either molecule”. Since the denominator takes into account the higher count of the ‘True’ valued nodes among the two molecules, differences in molecular weight are also automatically accounted for.

Pair-wise comparisons between all molecules can then be made and molecules with a similarity greater than 0.7 can be put into a cluster for each molecule. The initial number of clusters is thus equivalent to the number of input molecules. Clusters that have similar molecules can later be merged. The type of similarity coefficient and the cut-off for cluster membership are the parameters.

Several other clustering methods commonly followed in cluster analysis can be employed. For example, the first cluster can be seeded by the two most similar molecules. Other molecules can then merge with this cluster or form their own clusters with more similar molecules, depending on the similarity of these with molecules in the cluster and outside it. Similarly, molecules can be separated into clusters based on the similarities in their physico-chemical properties like molecular weight and whether they are straight chain or ring compounds.

The similarity coefficient according to one preferred embodiment can be based on the similarity of schemas for molecules, e.g., all molecules with similar level functional groups (such as, for example, level-one functional groups) can be clustered together. The coefficient can be defined to ensure that two molecules with similar counts of functional groups are not in the same cluster unless their size is also similar. While this constraint is described here as an example, it will be appreciated that other known coefficients of similarity can be used in keeping with the invention.

One embodiment provides for relating the count of functional groups to biological activity, e.g., to anti-asthma, anti-tuberculosis, inter alia. XQuery can be used to search for molecules in a test set having the same patterns/rules of functional groups. When scaling the application to an enterprise level, rule engines can be used to expeditiously automate knowledge and rule execution. Any of a variety of commercially available, proprietary or open-source rule engines can be used, so long as they support forward chaining and/or backward chaining operations such as, for example, the Haley Business Rules Engine, Haley™, Arlington, Va.; or the open-source program Zilonis™ (see for example URLs www.zilonis.org, www.jboss.com/products/rules, and others). Such a rule engine can utilize one of a number of alternative pattern-matching algorithms. Preferably this will be relatively efficient algorithm, such as the Rete algorithm, although many alternative algorithms can be used in accordance with the invention.

A Rule Base according to the invention can have a plurality of rules linking molecular characteristics, such as, for example, functional group characteristics, and different biological activities. Preferably an embodiment of the invention can have a Rule Base that contains more than 100 rules, more preferably more than 1000 rules, more preferably 5,000 rules and preferably in excess of 10,000 rules.

Rule Discovery Engine: XML parsers, Xquery and Xpath query languages can then be employed to find hierarchical node patterns that are the same in a given activity class or cluster. Similarly patterns that are absent in the whole class and in individual clusters are also noted. A parameter in the preferences section of the user interface allows comparisons out to the terminal nodes of a schema or at earlier branching levels. A preference can also be set for finding all patterns absent in all molecules in the class or all molecules in the clusters.

Setting the preference to looking for similar schema patterns to any depth and not necessarily out to the terminal nodes is desirable, since it allows generation of more generic rules. A preference for finding patterns in the schema that are absent in all molecules also aids in removing spurious false positives.

A hierarchical pattern is said to be common out to the terminal node or earlier if it occurs in all molecules in a cluster or class at least once. So the minimum count of a particular pattern occurring in all molecules in the class or cluster forms a single rule. For example, if there are two primary aliphatic alkanes, three carbonyl groups and two aromatic benzene rings that are common to all molecules in a class or in a cluster, then the above counts will define a rule. The rule can be enhanced by adding an upper bound to the counts. This upper bound can be the maximum count of a functional group in any one of the molecules in the class or cluster. Similarly, the counts of patterns in ring systems and atom types can also be used for rule formation.

The common hierarchical patterns can be conserved either out to the terminal node or at any earlier level. Occurrence of the pattern out to the terminal node in several molecules indicates more specificity, while that at an earlier node indicates more generality. However, even a general indication that a class of molecules has five occurrences of alkanes rather than alkenes and other groups is an important conclusion.

One embodiment according to the invention provides for a method whereby after obtaining an XML file that is generated by the Transformation Engine finds patterns common to a set of molecules using logic detailed above. This set of conserved patterns and their implied relationship with the biological activity or activities caused by these patterns (which relationship can be found by inference), such as, for example, an anti-asthma biological activity, comprise a rule stored in a Rule Base for later application by the Rule Application Engine.

The above approach is clearly distinct from most similarity algorithms that use substructures or fragments also use methods of bit-wise distances such as Tanimoto Coefficient and/or Euclidean distances for counts. These measures do not take into account the interrelationships between different types of chemical fragments. The method and system according to a preferred embodiment overcomes these limitations.

Rule Application Engine: Referring now to Module 3, (see FIG. 2C), once rules are discovered by the system and accepted by the user, they are stored in a rule engine as WHEN . . . THEN rules and in an XML file. As mentioned above, any Rule Engine that applies forward chaining and reverse chaining can be used to find potential activities or to confirm a particular activity, respectively. These rules can also be stored as XML files and used with direct application of XQuery on new molecules. A relational/XML database or even the filesystem can be used to store the XML rulesets.

When predicting the activities for a new set of molecules, the process discussed above is followed again. The molecular data in SDF or SMILES or some other format is converted to an XML file using the functional group, ring system and atom type schemas. The molecules are compared to the clusters obtained in the clustering step and the rulesets corresponding to molecules, similar to the current molecules, as defined in terms of a similarity coefficient are chosen.

A query is then performed on this XML file and True and False rules in the global rule and the applicable cluster are applied. All molecules that have the hierarchical schema patterns present in the rules and that have no patterns corresponding to the absent patterns as specified in the global and local rules are given as output. The activity class of the molecules is the same as the one for which the rules were derived. When clustering of input molecules is used, two sets of rules are produced by the Rule Discovery Engine, as mentioned earlier. One set of schema patterns that are present and absent are global ones and are valid for all molecules, whereas local rules are derived from clusters of molecules.

Thus, when the above query is applied on XML files of new molecules, it is mandatory for the molecules to have patterns in the global rules, but it can match any one or more of the local rules. In this manner, by incorporating global and local hierarchical similarities of functional groups, ring systems and atom types, molecules with activities similar to a known class can be discovered.

The above query can be applied to all molecules in a public or in-house corporate structure database, to find potential new indications or to flag toxicity problems. Similarly, molecules with high or low solubilities can also be flagged, based on the presence or absence of key functional groups, rings and atomtypes and their connections. The query can search the logic for similar hierarchical patterns. The common patterns, for all the molecules in a class and for clusters can then be treated as WHEN . . . THEN rules and are inserted into the rule base of any Rule Engine that supports backward and/or forward chaining. These rules can be saved in an xml file.

The rules obtained can be applied on a set of test molecules (such as, for example, 1920 bioactive and pharma molecules). All molecules can be converted in an XML format one by one by the Transformation Engine using the same schemas as used while discovering the rule and applying the query will check the pattern. After applying the Rules, a user can get a subset of molecules from the total number of input molecules.

Constrained Structure Generator: Referring now to Module 4 (See FIG. 2D), new molecular structures can be generated using graph-theoretic computer science algorithms that are constrained to follow rules for a specific class. For example, one might generate anti-inflammatory and anti-Cyclooxygenase-2-like molecules with less gastric toxicity.

Such structure generators can be the exhaustive ones that generate structures from molecular formulae or evolutionary algorithms. In case of the latter, the rule constraints act like fitness or selection functions. It is not necessary that computationally generated compounds exist in nature or are easily synthesizable.

Bioisosteres are chemical fragments or substructures that help retain the biological or pharmacological activity of molecules but are chemically distinct. Changing such fragments helps change other parameters like solubilities and overcome toxicological problems. In the present invention, all the functional groups, rings and atom types that are present in the individual molecules in the input but are not part of the rule, form bioisosteric entities. A library of such entities might be generated for specific activity classes and stored in a filesystem, rulebase, LDAP directories or databases.

One preferred embodiment of the invention provides for transforming SDF to XML, for using XQuery to find clusters of similar molecules and finding conserved functional groups for these clusters, for predicting whether or not a new set of molecules will follow the conserved patterns and thus potentially have the same activity, and for generating constitutional isomers that have the same patterns as the current activity. Unlike traditional methods where the scaffold or template is very important as a pharmacophore for activity, in this embodiment the minimally conserved functional groups can be the minimal but not sufficient condition for bioactivity, irrespective of whether these functional groups occur in the scaffold or as pendant R groups on the scaffold. Thus, when constitutional isomers are generated, those that have the same functional groups as in the rule for the bioactivity are likely to have a different scaffold and thus are of value in designing entirely new series of bioactive molecules.

Another example according to an embodiment of the present invention is herein provided. In this exemplary test, a training set of 49 drugs with known toxicity against the Central Nervous System was used to obtain functional group patterns indicating CNS toxicity. The input molecules were transformed to XML reflecting the functional group schema and then patterns were mined that were common to 23 subclusters formed during the clustering stage. The rules can be as follows:

Cluster 1—(Alkane:Secondary[2]) AND (Benzenering[1]) AND (Amine[1])

Cluster 2—(Alkane:Secondary[2]) AND (Benzenering[1]) AND (Amine:Tertiary[1])

Cluster 3—(Alkane:Secondary[2]) AND (Benzenering[2]) AND (Amine:Tertiary[1])

Cluster 4—(Alkane:Secondary[2]) AND (Benzenering[1]) AND (Amine:Tertiary[1]) AND (Alcohol[1])AND (Ether[1])

Cluster 5—(Alkane:Secondary[2]) AND (Alkene[1]) AND (Amine:Primary[1]) AND (Carbonyl:Carboxylic AcidDerivative:CarboxylicAcid[1])

Cluster 6—(Alkane:Primary[4]) AND (Amine:Tertiary[2]) AND (Disulfide[1]) AND (SulfenicDerivative[2]) AND (Thiocarbonyl[2])

Cluster 7—(Alkane:Secondary[1]) AND (Aniline[2]) AND (Benzenering[2]) AND (Amine:Tertiary[3]) AND (SulfenicDerivative[1])

Cluster 8—(Alkane:Secondary[1]) AND (Aniline[2]) AND (Benzenering[2]) AND (Amine:Tertiary[2]) AND (SulfenicDerivative[1])

Cluster9—(Alkane[4]) AND (Benzenering[2]) AND (Amine:Secondary[1]) AND (Carbonyl[1]) AND (ArylHalide:ArylChloride[2])

Cluster 10—(:Benzenering[2]) AND (Amine:Tertiary[1]) AND (Iminyl:ketimine:Secondary[1]) AND (Lactam[1]) AND (Carbonyl[1]) AND (ArylHalide:ArylChloride[1])

Cluster 11—(Alkane:Secondary[4]) AND (Aniline[2]) AND (Benzenering[2]) AND (Amine:Tertiary[2]) AND (SulfenicDerivative[1])

Cluster 12—(Alkane:Primary[4]) AND (Alkane:Secondary[6]) AND (Alkane:Tertiary[2]) AND (Alkane:Quartary[3]) AND (Benzenering[1]) AND (Phenol[1]) AND (Amine:Tertiary[1]) AND (Alcohol:Tertiary[1]) AND (Ether[2])

Cluster 13—(Alkane:Secondary[2]) AND (Benzenering[1]) AND (Amine:Tertiary[1])

Cluster 14—(Alkane:Primary[2]) AND (Alkane:Secondary[4]) AND (Alkane:Tertiary[1]) AND (Carbonyl:CarboxylicAcidDerivative:CarboxylicAcid[1])

Cluster 15—(:Benzenering[1]) AND (Amidine[2]) AND (Amine:Secondary[2]) AND (Guanidine[1]) AND (ArylHalide:ArylChloride[2])

Cluster 16—(Alkane:Primary[1]) AND (Alkane:Secondary[6]) AND (Alkane:Tertiary[1]) AND (Benzenering[1]) AND (Oxoarene[1]) AND (Amine:Tertiary[1]) AND (Lactam[1]) AND (ArylHalide:ArylFluoride[1])

Cluster 17—(Alkane:Primary[4]) AND (Alkane:Secondary[4]) AND (Alkane:Tertiary[3]) AND (Alkene[1]) AND (Benzenering[1]) AND (Amine:Secondary[1]) AND (Amine:Tertiary[3]) AND (Amide:Secondary[1]) AND (Lactam[2]) AND (Carbonyl[3])

Cluster 18—(:Benzenering[2]) AND (Iminoarene[1]) AND (Amine:Secondary[1]) AND (Amine:Tertiary[2]) AND (Enamide[1]) AND (ArylHalide:ArylChloride[1])

Cluster 19—(Alkane:Secondary[2]) AND (Benzenering[1]) AND (Amine:Secondary[1]) AND (Amine:Tertiary[1]) AND (Carbamate[1]) AND (Urethane[1]) AND (Carbonyl[1])

Cluster 20—(:Alkene[1]) AND (Benzenering[3]) AND (Amine:Tertiary[2])

Cluster 21—(:Benzenering[2]) AND (Amidine[1]) AND (Amine:Secondary[1]) AND (Amine:Tertiary[1]) AND (Ether[1]) AND (ArylHalide:ArylChloride[1])

Cluster 22—(:Benzenering[2]) AND (Amine:Secondary[2]) AND (Imide[1]) AND (Urea[1]) AND (Carbonyl[2])

Cluster 23—(Alkane:Secondary[1]) AND (Benzenering[1]) AND (Phenol[2]) AND (Amine:Primary[1]) AND (Carbonyl:CarboxylicAcidDerivative:CarboxylicAcid[1])

The test set consisted of 1233 antibiotics from PubChem. These were then run against the training set; that is, each molecule of the 1233 antibiotics was individually screened against all the 23 clusters. This resulted in 35 unique hits. None of the hits were present in the original training set.

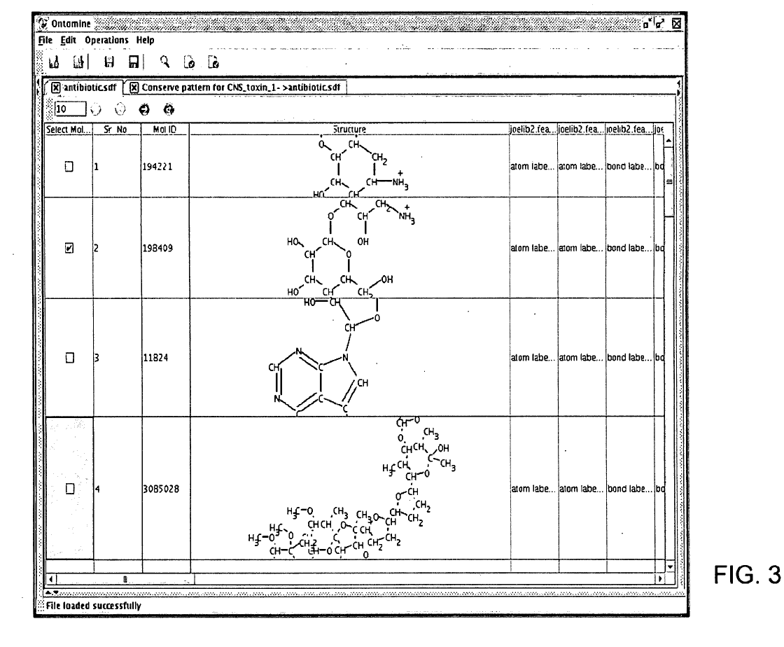

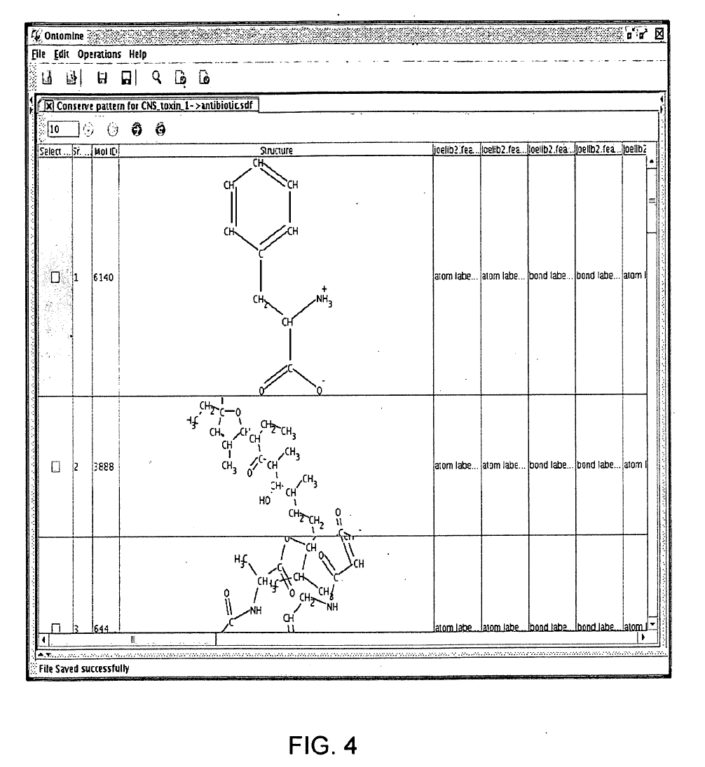

FIG. 3 depicts about 1233 Antibiotics that form a test set, out of which 35 molecules were predicted to have CNS toxicity. The toxicity and activity of these 35 molecules was checked in PubChem, PubMed, DrugBank, TOXNET and Google. FIG. 4: shows 53 hits obtained after running the test set against the training set rules.

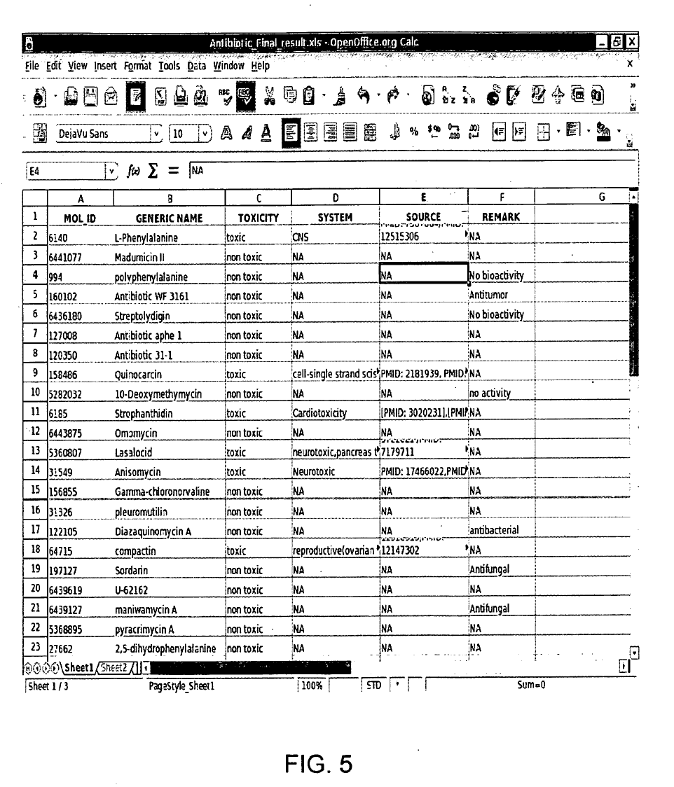

Case Study Conclusion: FIG. 5 shows the 35 hits cross-checked for toxicity With PubChem annotation Pubmed medical abstracts and available reference information from Google. Toxicity information was available for 9 out of the 35 predicted molecules. Out of these nine compounds, six were indeed found to be toxic to the nervous system. The remaining compounds were annotated as cytotoxic, cardiotoxic and toxic to reproductive cells and to the eye. There was no evidence to indicate that these were not CNS toxins. In general, further experiments would be required to rule out CNS toxicity for the 29 compounds flagged by the software.

The case study of this example clearly shows the value of the preferred embodiment in predicting toxicity by using simple conserved hierarchical functional groups. Usage of such rules in expert systems will aid drug discovery companies and regulatory authorities in prioritizing molecules for toxicity testing. This will substantially reduce the cost associated with drug discovery by identifying probable toxicities at a much earlier stage. The embodiment finds simple conserved functional group patterns that indicate the propensity for bioactivity. The current study showed that the simple rules output was very good at identifying CNS toxins. The rules are clearly understandable by the end user and can help in better drug design for maximizing therapeutic activity and minimizing the chance of toxicity that leads to regulatory failure.

The methods and system according to preferred embodiments of the invention are important when trying to analyze and discover the diverse nature of molecules that have a similar biological effect. Mining patterns common to many such biological levels as defined in ontologies such as MeSH and finding common chemical patterns, e.g., counts of functional groups at different levels of the functional groups hierarchy, enables construction of a dynamic structure-activity class knowledge base. Such knowledge bases can rapidly identify potential uses and warning signs for any molecule. Relational database systems, LDAP and XML, previously used for data storage, have now matured as informatics technologies and can be used advantageously according to the invention to store the patterns common to molecular classes. These patterns, when stored in a Rule Engine as rules, can form a Rule Base (the terms ‘Rule Base’ and ‘knowledge base’ are considered equivalent herein). These rules can then be applied as queries to newer molecules and can predict the activity class. A set of many such patterns is a Knowledge Base, relating structures to activities.

According to preferred embodiments of the invention, rules derived by the system and methods of the invention can be interpreted as non-alignment related pharmacophores, biophores or toxicophores, depending on the original dataset. The methods and system of invention can be used for finding potential uses of new molecular structures or potential problems (such as, for example, toxicity) prior to synthesis and screening using high throughput technologies. Drug discovery project managers can use the methods and system of invention to benchmark the probability of the success of the hit screening programs with reference to historical chemical trends. According to the invention, regulatory agencies using structure activity programs and alert systems for identifying toxicity and adverse effects can use the present methods and system to help define such alerts by means of the rule sets created. Medicinal and computational chemists can use the methods and system of invention for selecting molecules for High Throughput Screening or selecting and designing molecules likely to possess a particular activity.

Several references related to the field of present invention are herein provided to facilitate thorough understanding of the present invention. Yan S F, King F J, He Y, Caldwell J S, Zhou Y. Learning from the data: mining of large high-throughput screening databases. J Chem Inf. Model. (2006) November-December; 46(6):2381-95. Lameijer E W, Kok J N, Back T, Ijzerman A P. Mining a chemical database for fragment co-occurrence: discovery of “chemical clichés”. J. Chem Inf. Model. (2006) March-April; 46(2):553-62. King R D, Srinivasan A, Dehaspe L. Warmr: a data mining tool for chemical data. J Comput Aided Mol Des. (2001) February; 15(2):173-81. Kazius J, Nijssen S, Kok J, Back T, Ijzerman A P. Substructure mining using elaborate chemical representation. J Chem Inf. Model. (2006) March-April; 46 (2):597-605. Langton K, Patlewicz G Y, Long A, Marchant C A, Basketter D A. Structure-activity relationships for skin sensitization: recent improvements to Derek for Windows. Contact Dermatitis. 2006 December; 55(6):342-7. Zhou Y, Zhou B, Chen K, Yan S F, King F J, Jiang S, Winzeler E A. Large-scale annotation of small-molecule libraries using public databases. J Chem Inf Model. (2007) July-August; 47(4):1386-94. Epub 2007 Jul. 3. Payne M P, Walsh P T. Structure-activity relationships for skin sensitization potential: development of structural alerts for use in knowledge-based toxicity prediction systems. J Chem Inf Comput Sci. (1994) January-February; 34(1):154-61. Jarvis J, Seed M J, Elton R, Sawyer L, Agius R. Relationship between chemical structure and the occupational asthma hazard of low molecular weight organic molecules. Occup Environ Med. (2005) April; 62(4):243-50. Marchand-Geneste N, Watson K A, Alsberg B K, King R D. New approach to pharmacophore mapping and QSAR analysis using inductive logic programming. Application to thermolysin inhibitors and glycogen phosphorylase B inhibitors. J. Med Chem. Jan. 17(2002); 45(2):399-409.

While the present invention has been described in conjunction with preferred embodiment, one of ordinary skill, after reading the foregoing specification, will be able to effect various changes, substitutions of equivalents, and other alterations to the compositions and methods set forth herein. It is therefore intended that the patent protection granted hereon be limited only by the appended claims and equivalents thereof.

What is claimed is:

1. A method for analyzing relationship between molecular structure and biological activity in one or more molecules, the method comprising:
transforming molecular structure data into a hierarchical representation of chemical concepts and descriptors; and
detecting common tree-like patterns in the data.

2. The method of claim 1 further comprising:
defining distances between at least one selected from the group consisting of functional groups, ring systems, atoms, bond types, chemical concepts, chemical fragments and chemical descriptors, in at least an XML schema, at least a DTD or at least simple XML file.

3. The method of claim 2 further comprising:
grouping at least one set of molecules having structural data belonging to at least a common pharmacological origin or at least a common biological origin into at least one class, and
transforming the at least one class formed from the at least one set of molecules having structural data into a resultant XML file.

4. The method of claim 3 wherein the transforming the at least one class uses an XML template or schema file having a tree-like structure and the resultant XML file record file repeating the tree-like structure of the XML template file, once for each record.

5. The method of claim 4 further comprising:
querying the resultant XML file, based on at least one given classification selected from the group consisting of chemical, biological and pharmacological classification, to produce hierarchical patterns common to at least one group of molecules in the at least one class, and
generating at least one rule set for the at least one given chemical, biological or pharmacological classification.

6. The method of claim 5 comprising generating at least one rule set having a confidence level and salience that are proportional to the percentage of records and the depth of the tree to which they are conserved.

7. The method of claim 5 further comprising finding rules for continuous, binary, one class and/or multi-class data.

8. The method of claim 5 further comprising:
storing the generated rule set in a business rules engine or in a database.

9. The method of claim 5 further comprising:
inferring rules or patterns common to or distinct within a plurality of different biological classes and/or subclasses.

10. The method of claim 5 further comprising:
constructing an integrated knowledge base of rules using biological and functional classes as defined in the NCBI MeSH browser, PubChem pharmacological classes at different levels of activity including at least one selected from the group consisting of drug target level, biological process level, therapeutic level, disease level, clinical indication, syndrome level, toxicity and side effects.

11. The method of claim 5 further comprising:
finding bioisosteres by enumerating differences between functional groups, rings and atom types in the molecules, in a given class.

12. The method of claim 5 further comprising generating chemically feasible molecular structures from one or more molecular formulas of known drugs and drug-like molecules, and
inferring activities from the rules or from groups of rules for the chemically feasible molecular structures.

13. A computer based system for analyzing relationship between molecular structure and biological activity in one or more molecules, the system comprising:
a processor module; and
a memory module having stored therein set of computer instructions to instruct the processor module to perform the steps of:
transforming molecular structure data into a hierarchical representation of chemical concepts and descriptors; and
detecting common tree-like patterns in the data.
